(19) United States
(12) Patent Application Publication
(10) Pub. No.: US 2025/0376187 A1
(43) Pub. Date: Dec. 11, 2025

(54) CONTEXTUAL ATTRIBUTE-BASED PERCEPTION

(71) Applicant: AUTOBRAINS TECHNOLOGIES LTD, Tel Aviv-Yafo (IL)

(72) Inventors: Omer GOTTLIEB, Tel Aviv-Yafo (IL); Ziv KASSNER, Tel Aviv-Yafo (IL)

(73) Assignee: AUTOBRAINS TECHNOLOGIES LTD, Tel Aviv-Yafo (IL)

(21) Appl. No.: 18/739,221

(22) Filed: Jun. 10, 2024

(51) Int. Cl. B60W 60/00

(52) U.S. Cl. CPC B60W 60/00

(57) ABSTRACT

According to an embodiment, there is provided a method for contextual attribute-based perception, the method includes obtaining, by a processing circuit, contextual attributes generated at a machine learning process in association with a detected road element; identifying a selected group of contextual attributes in accordance with one or more criteria; and making, by the processing circuit, a determination with respect the detected road element, based on the selected group of contextual attributes

### BACKGROUND

Neural networks are employed in vehicles for various purposes including the classification of items sensed by sensors related to the vehicle.

Neural networks, even when extensively trained, may output erroneous classification decisions.

The erroneous classification decisions may be retrained or otherwise amended in order to correct the erroneous classification decisions. The retraining is time consuming, require extensive and costly software updates by a vehicle manufacturer.

There is a growing need to provide a more efficient way of solving erroneous classification decisions.

### SUMMARY

A method, system, and non-transitory computer readable medium as illustrated in the application.

### A BRIEF DESCRIPTION OF THE DRAWINGS

The embodiments of the disclosure will be understood and appreciated more fully from the following detailed description, taken in conjunction with the drawings in which:

FIG. 1 illustrates examples of vehicles and units;

FIG. 2 illustrates an example of a system;

FIG. 3 illustrates an example of units;

FIG. 4 illustrates an example of software and metadata;

FIG. 5 illustrates an example of a method.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

There is provided a method, a system, and a computer readable medium for contextual attribute-based perception.

According to an embodiment there is provided a method for contextual attribute-based perception, the method includes obtaining, by a processing circuit, contextual attributes generated at a machine learning process in association with a detected road element; identifying a selected group of contextual attributes in accordance with one or more criteria; and making, by the processing circuit, a determination with respect the detected road element, based on the selected group of contextual attributes.

A road element is an object or scene related to a road or any element that may impact a driving of a vehicle. Examples of road elements include a pedestrian, a vehicle, a traffic light, a road sign, a road marking, a zebra crossing, a weather condition at the road, and the like.

According to an embodiment, the method includes the one or more criteria is selected out of a road scenario, a requirement, and a performance indicator.

According to an embodiment, the method includes identifying a second group of contextual attributes in accordance with at least one of a road scenario, a requirement or a performance indicator that is different from the one above, the second group of contextual attributes being different from the selected group of contextual attributes; and making, by the processing circuit, a second determination with respect to the detected road element based on the second group of contextual attributes. This will provide further enrichment.

According to an embodiment, the method includes evaluating interdependencies between at least a portion of the contextual attributes, and making the determination based in the evaluation.

According to an embodiment, the making of the determination comprising identifying the selected group of the contextual attributes in accordance with an indication that corresponds to the autonomous driving application.

According to an embodiment, the method includes evaluating the detected road element with respect to the autonomous driving application and making the determination in accordance with the evaluation.

According to an embodiment, the method includes making a determination with respect to cross-autonomous driving applications, using the selected group of contextual attributes and according to another group of contextual attributes from the contextual attributes generated at the machine learning process in association with a plurality of detected road elements. According to an embodiment, the contextual attributes comprises behavioral attributes.

According to an embodiment, the contextual attributes comprise spatial attributes.

According to an embodiment, the contextual attributes comprise in-vehicle information.

According to an embodiment, the method includes making the selected group of contextual attributes available in association with the determination for the detected object for use, at a signature generation process, in generating a signature. Examples of generating signatures and/or cropping images are provided in U.S. patent application Ser. No. 18/527,701 which is incorporated herein by reference.

According to an embodiment, the machine learning process is trained to map the contextual attributes to information generated during a detection of the detected road element.

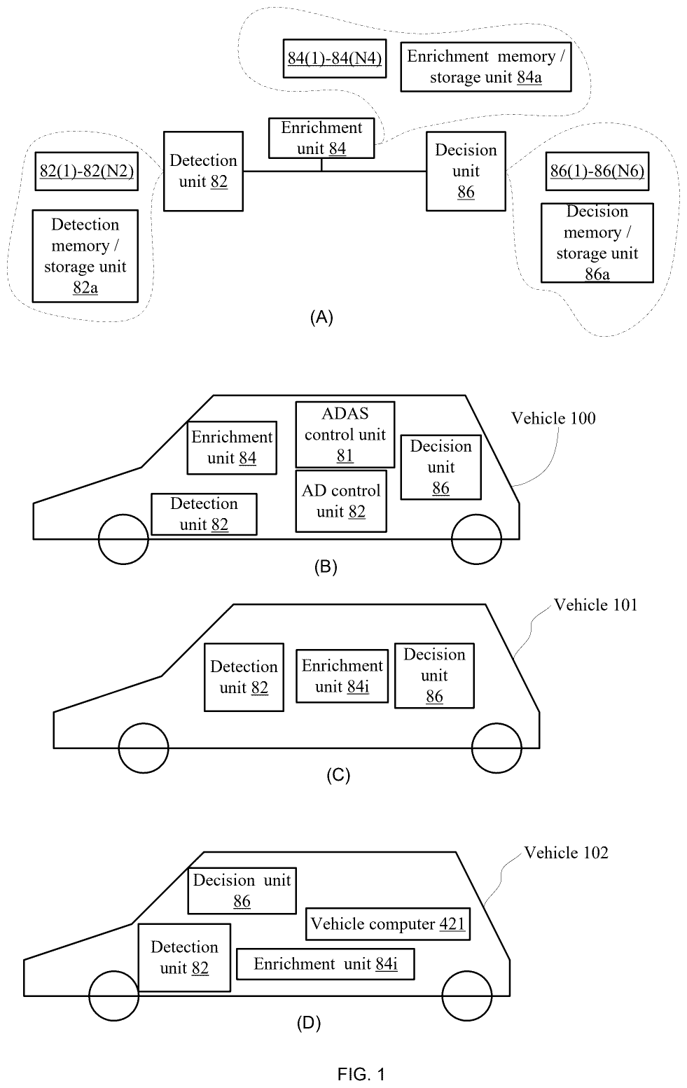

FIG. 1 (part A) illustrates an example of a detection unit 82, an enrichment unit 84 and a decision unit 86 that communicate in each other in order to enrich metadata (such as a selected group of contextual attributes) associated with a detected road element and to make a determination for the detected road element, based on the selected group of contextual attributes.

The detection unit 82 includes a first number (N2) of processing circuits 82(1)-82(N2) and a detection unit memory/storage unit 82a configured to store software (or any other forms of instructions and/or code) and/or information and/or metadata required for performing detection of elements such as objects, scenes, and the like.

The enrichment unit 84 is configured to provide a selected group of contextual attributes) associated with a detected road element and includes a second number (N4) of processing circuits 84(1)-84(N4) and an enrichment unit memory/storage unit 85a configured to store software (or any other forms of instructions and/or code) and/or information and/or metadata required for performing the selection.

The decision unit 86 is configured to make a determination for the detected road element, based on a selected group of contextual attributes from the contextual attributes identified with respect to an autonomous driving application, and includes a third number (N6) of processing circuits 86(1)-86(N6) and a decision unit memory/storage unit 86a configured to store software (or any other forms of instructions and/or code) and/or information and/or metadata required for making the decision based on the selected group of contextual attributes.

FIG. 1 (part B) illustrates a vehicle 100 that includes detection unit 82, enrichment unit 84, decision unit 86, advanced driver assistance system (ADAS) control unit 81 and autonomous driving (AD) control unit 82.

FIG. 1 (part C) illustrates a vehicle 101 that includes detection unit 82, enrichment unit 84, and decision unit 86.

FIG. 1 (part D) illustrates a vehicle 102 that includes detection unit 82, enrichment unit 84, decision unit 86, and vehicle computer 421.

The ADAS control unit 81 is configured to control ADAS operations.

The autonomous driving control unit 82 is configured to control autonomous driving of the autonomous vehicle.

The vehicle computer 421 is configured to control the operation of the vehicle-especially controlling the engine, the transmission, and any other vehicle system or component.

The vehicle computer 421 may be in communication with an engine control module, a transmission control module, a powertrain control module, and the like

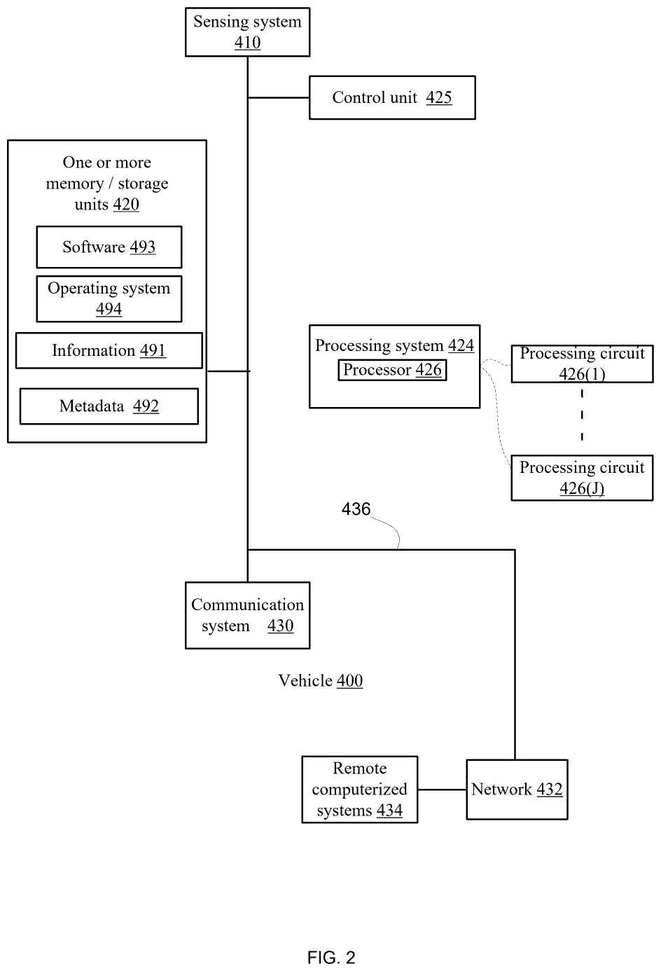

FIG. 2 illustrates an example of a computerized system 400 that includes communication system 430, one or more memory and/or storage units 420, processing system 424 including processor 426. The computerized system may be a server, a laptop, a desktop, or any other computer and may include or be in communication with a sensing unit and/or a controller.

According to an embodiment, computerized system 400 is in communication with network 432 and one or more other remote computerized systems 434 that are in communication with network 432.

According to an embodiment, the communication system 430 is configured to enable communication between the one or more memory and/or storage units 420 and/or the sensing system 410 and/or any one of the additional units and/or the network 432 (that is in communication with the remote computerized systems).

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example—any reference to processor should be applied mutatis mutandis to multiple processors, any reference to communication system 430 should be applied mutatis mutandis to multiple communication systems.

According to an embodiment, the one or more memory and/or storage units 420 includes one or more memory unit, each memory unit may include one or more memory banks.

According to an embodiment, the one or more memory and/or storage units 420 includes a volatile memory and/or a non-volatile memory. The one or more memory and/or storage units 420 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database-such as any database known in the art—such as DB2®, Microsoft® Access, Microsoft® SQL Server, Oracle®, mySQL, PostgreSQL, and the like.

The memory and/or storage units 420 are configured to store firmware and/or software, one or more operating systems, data and metadata required to the execution of any of the methods mentioned in this application.

The memory and/or storage units 420 was shown as storing software. Any reference to software should be applied mutatis mutandis to code and/or firmware and/or instructions and/or commands, and the like.

Various units and/or components are in communication with each other using any communication elements and/or protocols. An example of a communication system is denoted 430. Other communication elements may be provided.

The communication system 430 may be in communication with bus 436. The bus represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 432 that is located outside the vehicle and is used for communication between the vehicle and at least one remote computing system. By way of example, a remote computing system can be a personal computer, a laptop computer, portable computer, a server, a router, a network computer, a peer device, or other common network node, and so on. Logical connections between the processor and either one of remote computing systems can be made via a local area network (LAN) and a general wide area network (WAN). Such network connections can be through a network adapter (may belong to communication system 430) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 420 may be stored outside the vehicle. It should also be noted that the processor may evaluate signatures generated by a plurality of detectors.

According to an embodiment, the memory and/or storage units 220 stores at least one of: operating system 494, information 491, metadata 492, and software 493.

Using the software, the processing system is configured to execute one or more methods of method 900.

Vehicle 400 also includes sensing system 410 and control unit 425.

The control unit 425 may cooperate with an advanced driver assistance system (ADAS) control unit, an autonomous driving control unit 422 and/or may control or communicate with other vehicle components—including a vehicle computer.

The sensing system 410 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 410 is configured to output one or more sensed information units (SIUs).

The control unit 425 is configured to control the operation of the sensing system 410, and/or the one or more memory and/or storage units 420 and/or the one or more additional units (except the controller).

According to an embodiment, the one or more memory and/or storage units 420 includes one or more memory unit, each memory unit may include one or more memory banks.

According to an embodiment, the one or more memory and/or storage units 420 includes a volatile memory and/or a non-volatile memory. The one or more memory and/or storage units 420 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

By way of example and not meant to be limiting, computer readable media can comprise “computer storage media” and “communications media.” “Computer storage media” comprise volatile and non-volatile, removable, and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 430. Other communication elements may be provided.

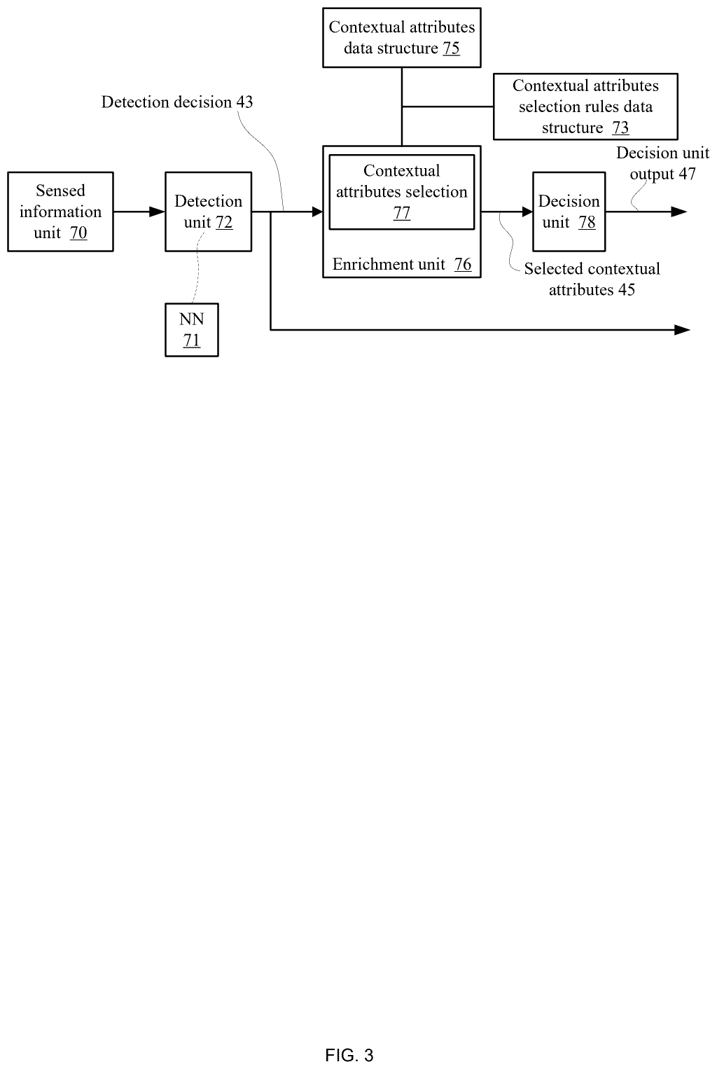

FIG. 3 illustrates an example of a detection unit 74, an enrichment unit 76, and a decision unit 78 in communication with each other.

The detection unit 74 is configured to receive a sensed information unit (SIU) 70 that may be unlabeled or only partially labeled (for example up to 10, 20, 30, 40 percent of the items in the sensed information unit are labeled), to feed the SIU 70 to the detection unit 72 (that includes a neural network (NN) 71). NN 71 may or may not be followed by a detection sub-unit (not shown), and the detection unit 72 outputs a detection decision 43 (such as an estimate of a class of an element captured by the SIU).

The detection decision 43 is fed to enrichment unit 76 that outputs selected contextual attributes 45 to decision unit 78. Enrichment unit 76 is in communication with a contextual attributes data structure 75 that stores contextual attributes and contextual attributes selection rules data structure 73 that stores contextual attributes selection rules that determine which contextual attributes to select per the detection decision.

The contextual attributes selection rules may be determined by any entity—for example a user, a services provider, an administrator of the system, a vehicle vendor, any other entity associated with the enrichment, any vendor or user of any hardware of software component related to the vehicle. For example, an entity may determine that only certain contextual attributes are relevant to his purposes and these certain contextual attributes should be provided to the decision unit 78.

For example, an entity may request to find out whether a pedestrian wears a hat or a safety jacket, or request to determine whether a certain road user behavior results in a damage.

According to an embodiment, the selected contextual attributes are used for providing relevant objects that conform to a specific driving function of an entity (for example—for Adaptive Cruise Control), and/or used for testing/or validating of certain requirements for a specified driving function, say identifying or testing/or validating cars on the immediate left and right only, and/or used for validation of a parking break/or an emergency brake on certain objects (vehicles/pedestrians/motorbikes/etc.), or used for validation or testing of an emergency break before a round-about.

When a vehicle function (for example AD function or ADAS function) is tested under certain circumstances and/or under certain KPIs the selected contextual attributes should be relevant to the certain circumstances and/or under certain KPIs.

According to an embodiment, the contextual attributes include an occlusion indicator indicative of whether a road elements is occluded (fully or partially or by what amount) by another a road element in the SIU.

According to an embodiment, the contextual attributes are indicative of the spatial relationship between a pedestrian and a road boundary, for example—whether a pedestrian is close to a curb.

According to an embodiment, the contextual attributes are indicative of an orientation of the vehicle or any other road element.

According to an embodiment, the contextual attributes are indicative of whether a pedestrian is about to cross the street or not.

According to an embodiment, the contextual attributes are indicative of whether a vehicle's wheels are touching the road or not.

According to an embodiment, the contextual attributes are indicative of vehicles present at the margins/shoulders of a paved road.

According to an embodiment, the contextual attributes are indicative of whether another vehicle is driven by a human driver or not.

The decision unit 78 is configured to make a determination for the detected road element, based on a selected group of contextual attributes from the contextual attributes identified with respect to an autonomous driving application. The decision unit 78 outputs a decision unit output 47 such as a command, a request, an instruction, metadata, an updated detection decision, and the like—that represents the determination.

According to an embodiment, the decision unit output 47 is sent to a memory/storage unit, and/or to a remote computerized system, and/or to a ADAS control unit, and/or to an AD control unit and/or to a vehicle computer and/or to the detection unit, and the like.

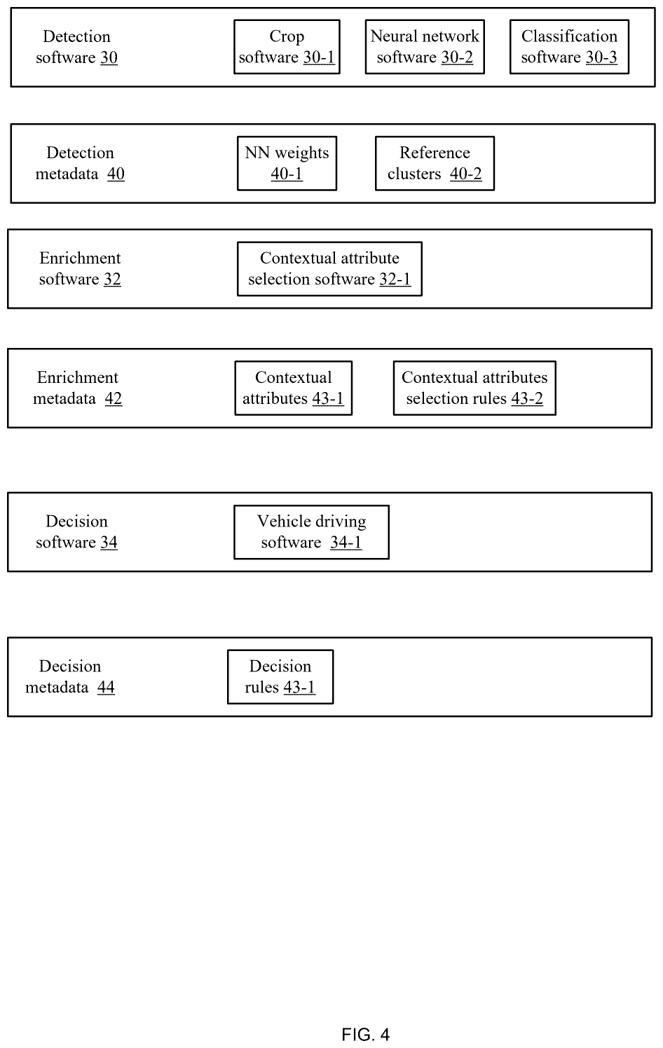

FIG. 4 illustrates examples of metadata and/or software stores in at least one memory/storage units out of detection memory/storage unit 82a, enrichment memory/storage unit 84a, and decision memory/storage unit 86a.

The examples include detection software 30 and detection metadata 40 for facilitating the operation of the detection unit, enrichment software 32 and enrichment metadata 42 for facilitating the operation of the enrichment unit (74, 84), and decision software 34 and decision metadata 44 for facilitating the operation of the decision unit.

Examples of detection software 30 include crop software 30-1 for generating a cropped image, neural network software 30-2 (used for implementing 71) and classification software 30-3.

Examples of detection metadata 40 include NN weights 40-1, and reference clusters 40-2 to which an NN signature is compared during classification.

Examples of enrichment software 32 include contextual attribute selection software 32-1.

Examples of enrichment metadata 42 includes decision rules 43-1, issue detection parameters 43-2, and performance indication 43-3.

Examples of decision software 34 include signal generation software 34-1.

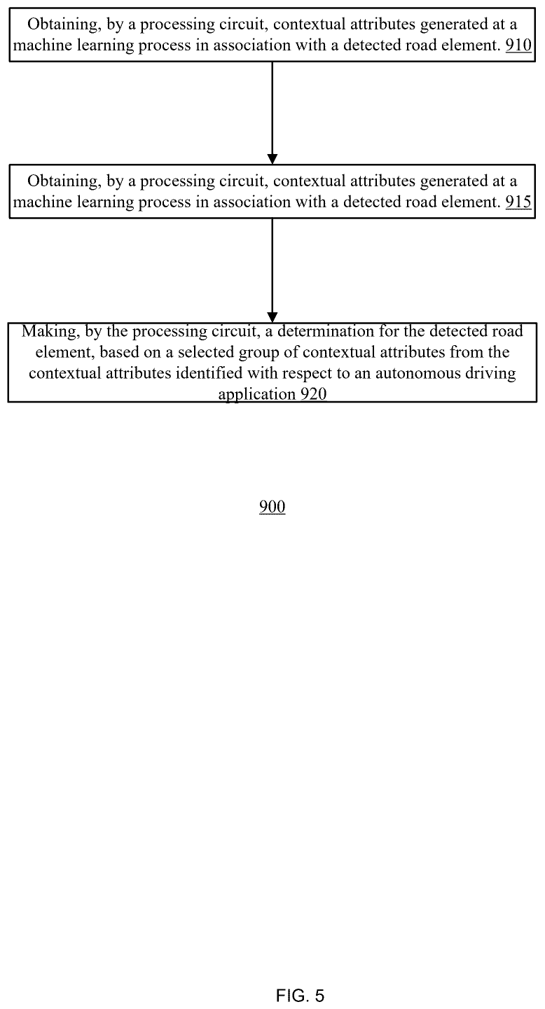

FIG. 5 illustrates an example of method 900 for contextual attribute-based perception.

According to an embodiment, method 900 includes step 910 of obtaining, by a processing circuit, contextual attributes generated at a machine learning process in association with a detected road element. According to an embodiment, the processing circuit is a part of a decision unit.

According to an embodiment, step 910 is followed by step 915 of identifying a selected group of contextual attributes in accordance with one or more criteria.

According to an embodiment, the one or more criteria is at least one of a road scenario, a requirement, and a performance indicator. The one or more criteria is an example of a contextual attribute selection rules.

According to an embodiment the one or more criteria may be determined by any entity—for example a user, a services provider, an administrator of the system, a vehicle vendor, any other entity associated with the enrichment, any vendor or user of any hardware of software component related to the vehicle. For example, an entity may determine that only certain contextual attributes are relevant to his purposes and these certain contextual attributes should be provided to step 920.

For example, an entity may request to find out whether a pedestrian wears a hat or a safety jacket, or request to determine whether a certain road user behavior results in a damage.

According to an embodiment, the one or more criteria are used for providing relevant objects that conform to a specific driving function of an entity (for example—for Adaptive Cruise Control), and/or used for testing/or validating of certain requirements for a specified driving function, say identifying or testing/or validating cars on the immediate left and right only, and/or used for validation of a parking break/or an emergency brake on certain objects (vehicles/pedestrians/motorbikes/etc.), or used for validation or testing of an emergency break before a round-about.

According to an embodiment, step 915 is followed by step 920 of making, by the processing circuit, a determination with respect to the detected road element, based on the selected group of contextual attributes.

According to an embodiment, step 920 includes evaluating interdependencies between at least a portion of the contextual attributes, and making the determination based in the evaluation.

According to an embodiment, step 920 includes identifying the selected group of the contextual attributes in accordance with an indication that corresponds to the autonomous driving application. The indication is indicative of a mapping between the detected road element and the selected group. For example—an ADAS control unit (or an AD control unit) may be instructed to perform an ADAS operation (or an AD operation) based on certain contextual attributes while ignoring other contextual attributes,

According to an embodiment, step 920 includes evaluating the detected road element with respect to the autonomous driving application and making the determination in accordance with the evaluation.

According to an embodiment, step 910 includes making a determination with respect to cross-autonomous driving applications, using the selected group of contextual attributes and according to another group of contextual attributes from the contextual attributes generated at the machine learning process in association with a plurality of detected road elements.

According to an embodiment, method 900 further includes (i) identifying a second group of contextual attributes in accordance with at least one of a road scenario, a requirement or a performance indicator that is different from the one above, the second group of contextual attributes being different from the selected group of contextual attributes; and (ii) making, by the processing circuit, a second determination with respect to the detected road element based on the second group of contextual attributes.

According to an embodiment, the contextual attributes include behavioral attributes of one or more road users.

According to an embodiment, the contextual attributes include spatial attributes related to road elements—such as distance, direction, and the like.

According to an embodiment, the contextual attributes include in-vehicle information such as information regarding the progress of the vehicle, a status of one or more vehicle components, and the like.

According to an embodiment, the method includes making the selected group of contextual attributes available in association with the determination for the detected object for use, at a signature generation process, in generating a signature.

According to an embodiment, the machine learning process is trained to map the contextual attributes to information generated during a detection of the detected road element. According to an embodiment, the training is supervised or unsupervised or non-supervise, and the like.

Any combination of any step of any method illustrated in the application is provided.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarding the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of transformation module, active learning module, or clustering module, or any other module described herein, may be implemented in hardware and/or code, instructions and/or commands stored in a non-transitory computer readable medium, may be included in a vehicle, outside a vehicle, in a mobile device, in a server, and the like.

The vehicle may be any type of vehicle-such as a ground transportation vehicle, an airborne vehicle, or a water vessel.

The specification and/or drawings may refer to an image. An image is an example of a media unit. Any reference to an image may be applied mutatis mutandis to a media unit. A media unit may be an example of sensed information. Any reference to a media unit may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors-such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an object may be applicable to a pattern. Accordingly-any reference to object detection is applicable mutatis mutandis to a pattern detection.

A situation may be a singular location/combination of properties at a point in time. A scenario is a series of events that follow logically within a causal frame of reference. Any reference to a scenario should be applied mutatis mutandis to a situation.

The sensed information unit may be sensed by one or more sensors of one or more types. The one or more sensors may belong to the same device or system- or may belong to different devices of systems.

We claim:

1. A method for contextual attribute-based perception, the method comprises:
obtaining, by a processing circuit, contextual attributes generated at a machine learning process in association with a detected road element;
identifying a selected group of contextual attributes in accordance with one or more criteria; and
making, by the processing circuit, a determination with respect the detected road element, based on the selected group of contextual attributes.

2. The method of claim 1, further comprising: identifying a second group of contextual attributes in accordance with at least one of a road scenario, a requirement or a performance indicator that is different from the one above, the second group of contextual attributes being different from the selected group of contextual attributes; and making, by the processing circuit, a second determination with respect to the detected road element based on the second group of contextual attributes.

3. The method according to claim 1, wherein the one or more criteria is selected out of a road scenario, a requirement and a performance indicator.

4. The method according to claim 1, comprising evaluating interdependencies between at least a portion of the contextual attributes, and making the determination based in the evaluation.

5. The method according to claim 1, where the making of the determination comprising identifying the selected group of the contextual attributes in accordance with an indication that corresponds to the autonomous driving application.

6. The method according to claim 1, comprising evaluating the detected road element with respect to the autonomous driving application, and making the determination in accordance with the evaluation.

7. The method according to claim 1, comprising making a determination with respect to cross-autonomous driving applications, using the selected group of contextual attributes and according to another group of contextual attributes from the contextual attributes generated at the machine learning process in association with a plurality of detected road elements.

8. The method according to claim 1, wherein the contextual attributes comprises behavioral attributes.

9. The method according to claim 1, wherein the contextual attributes comprise spatial attributes.

10. The method according to claim 1, wherein the contextual attributes comprise in-vehicle information.

11. The method according to claim 1, comprising making the selected group of contextual attributes available in association with the determination for the detected object for use, at a signature generation process, in generating a signature.

12. The method according to claim 1, wherein the machine learning process is trained to map the contextual attributes to information generated during a detection of the detected road element.

13. A non-transitory computer readable medium for contextual attribute-based perception, the non-transitory computer readable medium comprises:
obtaining, by a processing circuit, contextual attributes generated at a machine learning process in association with a detected road element;
identifying a selected group of contextual attributes in accordance with one or more criteria; and
making, by the processing circuit, a determination with respect the detected road element, based on the selected group of contextual attributes.

14. The non-transitory computer readable medium according to claim 13, storing instructions for: identifying a second group of contextual attributes in accordance with at least one of a road scenario, a requirement or a performance indicator that is different from the one above, the second group of contextual attributes being different from the selected group of contextual attributes; and making, by the processing circuit, a second determination with respect to the detected road element based on the second group of contextual attributes

15. The non-transitory computer readable medium according to claim 13, wherein the one or more criteria is selected out of a road scenario, a requirement, and a performance indicator.

16. The non-transitory computer readable medium according to claim 13, storing instructions for evaluating interdependencies between at least a portion of the contextual attributes, and making the determination based in the evaluation.

17. The non-transitory computer readable medium according to claim 13, where the making of the determination storing instructions for identifying the selected group of the contextual attributes in accordance with an indication that corresponds to the autonomous driving application.

18. The non-transitory computer readable medium according to claim 13, storing instructions for evaluating the detected road element with respect to the autonomous driving application, and making the determination in accordance with the evaluation.

19. The non-transitory computer readable medium according to claim 13, storing instructions for making a determination with respect to cross-autonomous driving applications, using the selected group of contextual attributes and according to another group of contextual attributes from the contextual attributes generated at the machine learning process in association with a plurality of detected road elements.

20. The non-transitory computer readable medium according to claim 13, wherein the contextual attributes comprises behavioral attributes.
